(19) United States
(12) Patent Application Publication
(10) Pub. No.: US 2005/0014563 A1
(43) Pub. Date: Jan. 20, 2005

(54) Interactive DVD gaming system

(76) Inventor: Darin Barri, El Segundo, CA (US)

Correspondence Address: KOLISCH HARTWELL, P.C., 520 S.W. YAMHILL STREET, SUITE 200, PORTLAND, OR, 97204, US

(21) Appl. No.: 10/801,447

(22) Filed: Mar. 12, 2004

Related U.S. Application Data
(60) Provisional application No. 60/454,535, filed on Mar. 12, 2003.

(51) Int. Cl. A63F 13/00

(52) U.S. Cl. 463/43

(57) ABSTRACT

An interactive game is provided for use with a conventional DVD player configured to play DVD-Video discs. Some embodiments of the game include DVD media having scripts recorded thereon, to use the available memory storage means of a conventional DVD player to hold game variables. The variables in turn may be used by scripts to control game flow by implementing logical decisions based on the values of one or more variables, user-provided game input, or a combination thereof. Such decisions may include implementing other scripts, setting or changing values of game variables, playing audiovisual content, etc., to enable game play. Some embodiments of the game include a user-operated control adapted to distinguish among external input sources, for example to determine which of a plurality of players provides game input.

### CROSS-REFERENCE TO RELATED APPLICATIONS

This application claims priority to U.S. Provisional Patent Application Ser. No. 60/454,535, filed Mar. 12, 2003, and entitled “Interactive Games”.

### BACKGROUND

A popular format of game is the “video game,” in which a player interacts with a gaming system that has a video screen. While video games are popular, they are relatively expensive. Arcades and other commercial establishments provide such games on a pay-to-play basis, so that a user must continually pay to play the game. Gaming consoles are manufactured and sold to consumers who wish to enjoy video games at home. However, such consoles and their compatible games are typically quite expensive.

### SUMMARY

An interactive game is provided for use with a conventional DVD player configured to play DVD-Video discs. Some embodiments of the game include DVD media having scripts recorded thereon, to use the available memory storage means of a conventional DVD player to hold game variables. The variables in turn may be used by scripts to control game flow by implementing logical decisions based on the values of one or more variables, user-provided game input, or a combination thereof. Such decisions may include implementing other scripts, setting or changing values of game variables, playing audiovisual content, etc., to enable game play. Some embodiments of the game include a user-operated control adapted to distinguish among external input sources, for example to determine which of a plurality of players provides game input.

### BRIEF DESCRIPTION OF THE DRAWINGS

FIG. 1 is a block diagram of a gaming system according to the present disclosure.

FIG. 2 is a block diagram of a DVD gaming system according to the present disclosure.

FIG. 3 is a block diagram of a DVD player of the DVD gaming system of FIG. 2, showing eight general parameter register memories (GPRMs), each GPRM having sixteen bits.

FIG. 4 is a block diagram of a DVD game remote of the DVD gaming system of FIG. 2.

FIGS. 5A and 5B show examples of an opening menu screen of a DVD game.

FIG. 6 is a flow chart showing options available at the opening menu screen of FIGS. 5A and 5B, and corresponding scripts that may be run upon selection of available options.

FIG. 7 is a flow chart showing game play of a Trivia Game according to one embodiment of the DVD gaming system of this disclosure.

FIGS. 8A-8I show examples of screens displayed during game play of the Trivia Game of FIG. 7.

### DETAILED DESCRIPTION

Digital Versatile Discs, or DVDs, are optically readable media capable of storing relatively large quantities of digital information, which may be subsequently accessed by a complementarily configured DVD player, such a conventional DVD player, a personal computer DVD player, etc.

Most DVD media are 4.7 inch discs with a 0.05 inch thickness. DVD media store data on spiral tracks, which is read from the media with an extremely fine, precisely aimed laser. Data takes the form of millions of indentations, or “data pits,” arranged along the spiral tracks of the media. The data pits refract light, which reduces the intensity of reflected light. Sensors register the difference in reflection intensity as binary data.

DVD media generally have a greater storage density and increased stability when compared to many other storage media, such as magnetic storage media or other optical storage media, such as compact discs (CDs).

For example, DVD media are capable of storing more tracks per disc than a CD because the tracks may be placed closer together on DVDs than on CDs. The distance between tracks, or “track pitch,” is approximately 0.74 microns, which is less than half that of a CD (1.6 microns). Also, the data pits on a DCD are considerably smaller than on a CD. Accordingly, the average DVD media holds four times the number of data pits that can be held by a CD. The average capacity of a single-sided, single-layered DVD is 4.7 gigabytes (GB).

Some DVD media utilize techniques such as layering and two-sided manufacturing to achieve even larger storage capacities. With layering, DVD media may be constructed with two layers, the outer layer of which is semi-transparent to allow reading of an underlying layer. The reading laser may operate at a relatively high intensity to read the inner layer, and a relatively low intensity to read the outer layer. A single-sided, double-layered DVD has a storage capacity of approximately 8.5 GB. To increase storage capacity to approximately 17 GB, both sides of a disc can be used to store digital information.

Also, the efficiency of the data structure on a DVD is generally much better than that of a CD. When CDs were first developed, considerable error correction was necessary to ensure that a CD would play correctly. Therefore, more bits were used for error detection and correction, which limited the capacity of a CD to carry useable digital information. The more efficient error correction code used with a DVD allows increased capacity for useable digital information.

Data on DVD media may be stored in a variety of formats. For example, computer applications, files, and other data may be stored using the DVD-ROM format. High quality audio may be stored using the DVD-A format. Full-length feature films are commonly stored on DVD media using the DVD-Video Standard, which utilizes MPEG-2 video compression and decompression.

DVD-Video discs are typically formatted to include up to ninety-nine titles, which may each be subdivided into ninety-nine chapters. Therefore, there are generally about 9,800 total chapters available on each disc. Each chapter may contain a “scene” comprised of audio or video information, or some combination thereof, which linearly plays from beginning to end. However, a particular chapter may not be dynamically altered. In other words, the content of each chapter does not change from one viewing to the next. Each chapter may additionally or alternatively contain information such as scripts and stories, used herein to refer to instructions readable and executable by a conventional DVD player.

Typical game media includes code executed by a game processor to establish a game engine that generates a “scene” based on input received from a user or based on random calculations performed by the game processor, and/or dynamically alters such a scene in real-time. A DVD-Video disc, in contrast, may be practically limited to showing no more than about 9,800 pre-recorded scenes. However, such scenes may be played in any order or in any combination.

Also, typical gaming consoles such as pay-to-play arcade games, personal computers, and hand-held gaming devices are equipped with large amounts of Random Access Memory (RAM) to hold game information. Conventional DVD players, in contrast, are not equipped with RAM specifically configured for gaming purposes. In general, conventional DVD players are designed for the sole purpose of playing high quality audio and video content. Therefore, in order to keep costs low, conventional DVD players are typically equipped with the minimum amount of resources to play encoded audio and video content. Thus, because large amounts of RAM are not needed for this purpose, conventional DVD players do not include large amounts of RAM.

Furthermore, the above-mentioned gaming systems are usually capable of receiving a series of real-time commands in rapid succession from a game controller, such as a joystick or a tethered control pad. In contrast, because the only required input are playback control commands such as “Play,” “Pause,” “Stop,” “Fast Forward,” “Rewind,” “Menu,” “Enter,” etc., which typically are not executed immediately one after the other, conventional DVD players typically include infrared input that is not configured to receive a series of real-time commands in rapid succession.

However, conventional DVD players typically include a minimal amount of onboard memory to enable the menuing features of some DVDs, and to facilitate playing one of several possible alternate audio tracks, using one of several possible camera angles, displaying one of several possible subtitles, etc. Accordingly, some embodiments of the DVD gaming system of this disclosure include DVD media having scripts recorded thereon, readable by a conventional DVD player, to use the available memory of such a DVD player to define game variables, which in turn may be used to control game flow. In these and other embodiments, such variables may be used by scripts on the DVD to implement a series of logical decisions based on the held values of the one or more game variables, on user-provided input, or some combination thereof. These decisions may include performing actions such as implementing other scripts, setting or modifying values of game variables, playing a specific scene or combination of scenes, or any combination thereof, to enable game play. As an example, some game variables may be used to track or change scores for one or more players of the game.

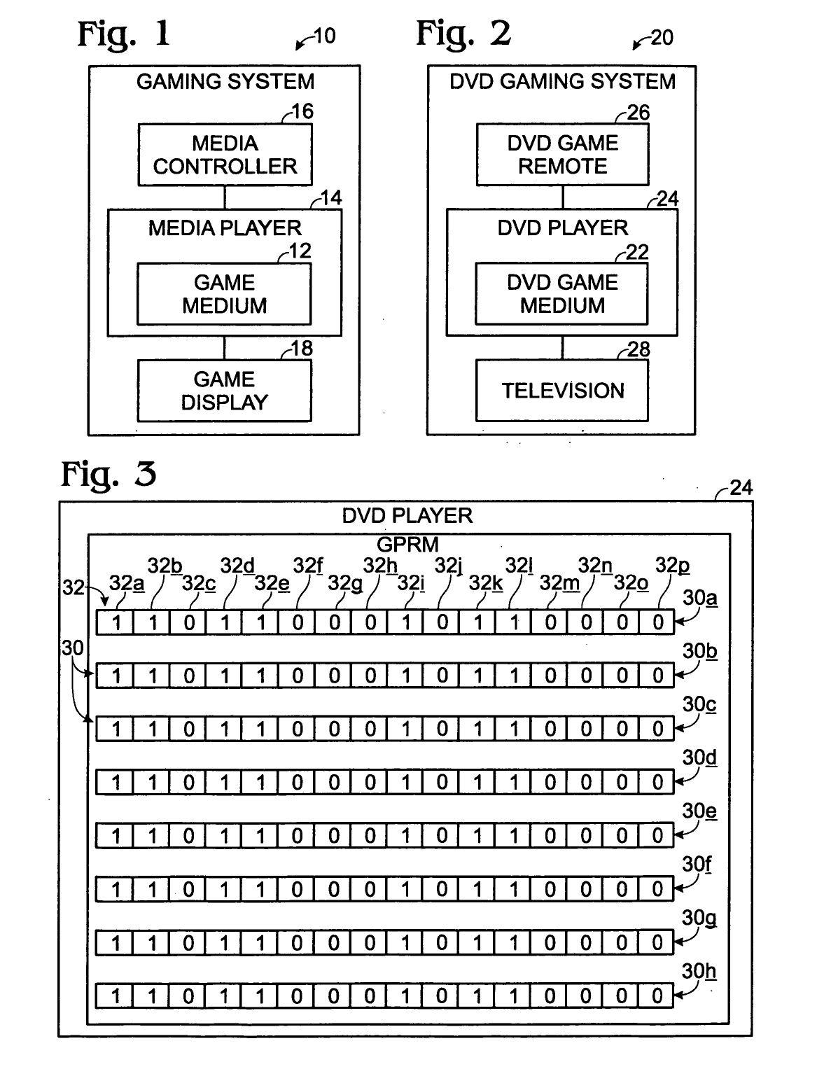

FIG. 1 shows a block diagram of a gaming system 10. The gaming system includes at least one game medium 12, a media player 14, a media controller 16, and a game display 18. Game medium 12 includes stored information, which may be utilized by media player 14 to present a game on game display 18. Media controller 16 serves as an interface between a user and the gaming system, so that the user may interactively control the game. Gaming system 10 may be configured in various embodiments. For example, game medium 12 may take the form of a DVD or another suitable storage medium. Similarly, media player 14 may take the form of a conventional DVD player if the gaming system utilizes DVD game media, or, if another type of game medium is used, a player complementarily configured to play that type of medium. Media controller 16 may be an external input source such as a general purpose controller configured to control a number of different games, or a game-specific controller particularly configured for use with a particular game. The particular embodiments of game system 10 that are described below should not be considered as limiting, but rather as providing illustrative examples of the numerous possible configurations and features that are within the scope of this disclosure.

FIG. 2 shows an embodiment of game system 10, in the form of a DVD gaming system 20. DVD gaming system 20 includes at least one DVD game medium 22, a conventional DVD player 24, a DVD game remote 26, and a television 28. DVD game system 20 is adapted to play games on conventional DVD player 24.

Accordingly, the digital information stored on DVD game medium 22 may be formatted and arranged to utilize the minimal memory of conventional DVD players, such as DVD player 24. DVD game medium 22 may store information corresponding to one or more games, and different DVD game media may store information corresponding to other games. Various DVD game media may be used to play different games on DVD player 24. However, in contrast to standard gaming consoles that require proprietary players to play proprietary media, DVD player 24 does not need to be specially configured to play games stored on DVD game medium 22. Instead, DVD game medium 22 may include information instructing DVD player 24 to store variables and implement logical decisions based on the values of the variables, to enable a user to play a game or games via DVD gaming system 20.

In FIG. 3, DVD player 24 is shown schematically to include eight general parameter register memories (GPRMs) 30, each of which is configured to hold sixteen bits 32 of data. Therefore, DVD player 24 includes 128 bits of memory. Each bit 32 is typically capable of holding one of two possible values, conventionally represented as a zero or a one. GPRMs are typically provided to enable menuing options and for controlling played content.

Although DVD player 24 is shown to include memory storage in the form of eight GPRMs 30, many conventional DVD players may include sixteen GPRMs and 24 system parameter register memories (SPRMs), each of which are configured to hold sixteen bits of data, for a total of 640 bits (or 80 bytes) of memory. Some conventional DVD players include more memory, depending on the configuration and number of GPRMs, SPRMs, and/or other memory storage means. Thus, conventional DVD players, as the term is used in this disclosure, generally include less than 1 kilobyte (1,024 bytes, or 8,192 bits) of onboard memory.

Thus, although the capacity of conventional DVD players to store information may be extremely limited as compared with a traditional gaming console, such memory storage may be used to hold data corresponding to one or more game variables, which may be used to control game play. Specifically, GPRMs 30 of DVD player 24 may store game information. For example, if DVD game medium 22 includes a trivia game, the first six bits 32a-f of GPRM 30a may be used to hold data corresponding to a “Questions” variable, which may represent the number of questions asked during a particular game. If six bits 32 are allocated to the Questions variable, the variable may hold one of sixty-four (2⁶) possible values, such as any number from zero to sixty-three.

Similarly, bit 32g of GPRM 30a may be used to store a “Multiplayer” variable or flag. If only one bit 32 is allocated to the Multiplayer flag, it may hold one of two (2¹) possible values. In this manner, it is possible to track whether the current game is a single player game, represented, for example, by a held zero, or a multiplayer game, represented by a held one.

As can be seen, each GPRM 30 may be segmented, such as by using bit shifting techniques, to hold more than one variable. Thus, other bits of GPRM 30a, as well as GPRMs 30b-h, may be used to hold other variables. Furthermore, it should be understood that some games may utilize more or fewer GPRMs 30, and/or other storage mechanisms, for holding values corresponding to game variables.

Because DVD gaming system 20 utilizes a conventional DVD player, a user who has already purchased and set up such a DVD player may play games without having to purchase a separate gaming console or connect additional equipment to the user's television, which may not have the appropriate inputs for connecting such equipment. This feature of DVD gaming system 20 may be advantageous to game developers and retailers, because more individuals have access to conventional DVD players than to proprietary game consoles. Thus, games played on a conventional DVD player may appeal to a broader demographic, including individuals who may be unable to, or do not desire to, play games on proprietary gaming consoles.

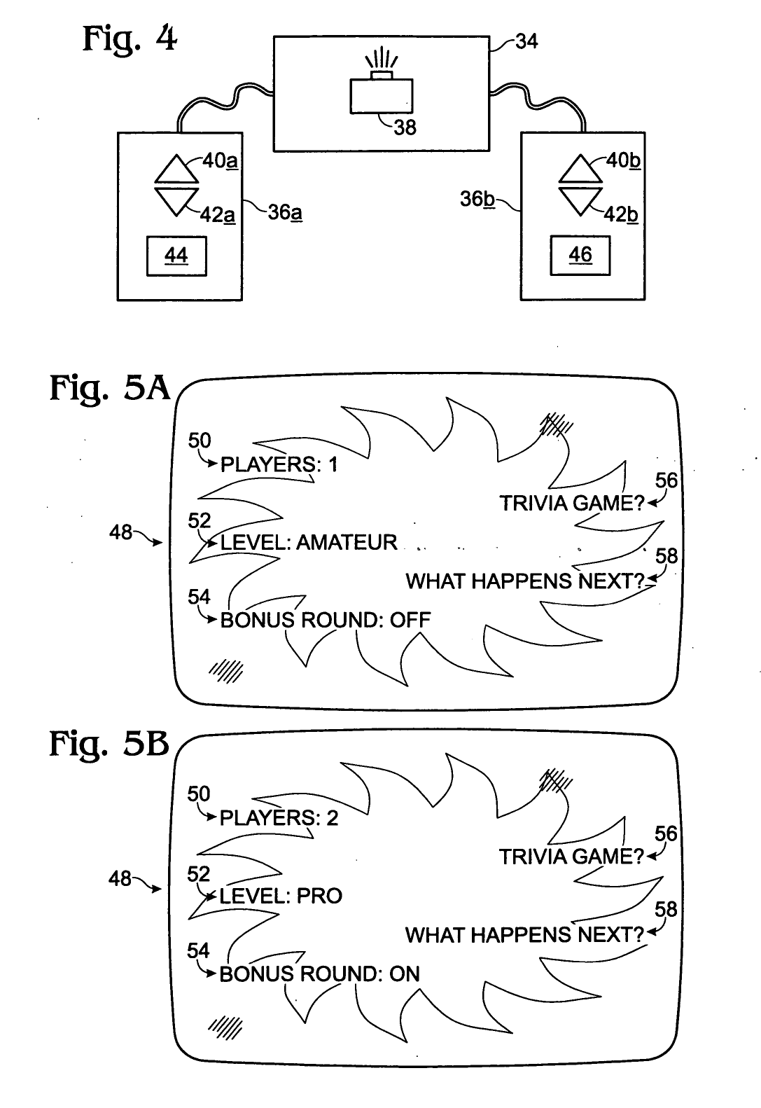

In some embodiments, DVD player 24 accepts input from DVD game remote 26, a user-operated control used by players to interact with or control DVD gaming system 20. As schematically shown in FIG. 4, one embodiment of DVD game remote 26 includes a communication subsystem 34 and player controls 36a and 36b, which may function as separate external input sources. Communication subsystem 34 includes a light emitting diode (LED) 38, configured to transmit wireless commands to DVD player 24. To facilitate the use of DVD game remote 26 with a variety of different DVD players, communication subsystem 34 may include universal remote control circuitry, which allows LED 38 to be programmed to communicate with a particular DVD player, such as DVD player 24. If configured with universal remote control circuitry, LED 38 may be programmed by entering a code corresponding to a particular DVD player. In some embodiments, the DVD game remote may be programmed by directing a signal from another remote to an optional signal detector of the DVD game remote. LED 38 may additionally or alternatively be programmed by running an automatic detection query in which DVD game remote 26 transmits different signals until a signal corresponding to a particular DVD player is found.

Player controls 36a and 36b are shown to include buttons, which may correspond to various commands associated with a particular game. The buttons may be mapped by the universal remote circuitry to correspond to signals readable by a conventional DVD player, to cause a specific response by the DVD player. Similar buttons on different controls may be mapped to produce the same signals or different signals. For example, player control 36a includes buttons 40a and 42a, which may be mapped to produce “Up” and “Down” signals, respectively. Player control 36b includes similar buttons 40b and 42b, which may also be mapped to produce similar “Up” and “Down” signals, respectively. However, button 44 on player control 36a may be mapped to produce a “Menu” signal, whereas similar button 46 on player control 36b may be mapped to produce an “Enter” signal. Thus, buttons 44 and 46 are each mapped to produce a signal that buttons on the other player control are not configured to produce. Such signals may be used to distinguish between external input sources when it is important to determine which player is providing input.

To illustrate, in the pictured embodiment, the buttons of DVD game remote 26 correspond to specific game actions. Buttons 44 and 46 are “buzz in” buttons, used to indicate that a player knows the answer to a question that is presented during the course of a game. When a player wants to attempt to answer the question, the player may press the “buzz in” button on his or her corresponding player control. In a two-player game in which player control 36a is used by one player and player control 36b is used by the other, if button 44 is pressed, DVD game remote 26 generates a “Menu” signal. If button 46 is pressed, an “Enter” signal is generated. The different signals generated indicate which player is first to “buzz in” by determining which signal input is provided first. Other buttons, such as 40a and 40b, or 42a and 42b, are mapped to produce the same signals regardless of the external input source.

Player controls 36a and 36b are shown coupled to communication subsystem 34. Alternatively, player controls may be configured for wireless communication with the communication subsystem. In other embodiments, each player control may include its own communication subsystem instead of sharing a common communication subsystem. The embodiment or embodiments of the external input source used, such as a DVD game remote and/or individual player controls, may be specifically configured for a particular game, or may be configured to work with different games. For example, the player controls may include removable faceplates that are designed for use with specific games, so that when a particular game is played, a faceplate corresponding to that game may be attached to each player control. The faceplates may indicate what the different buttons are used for, as well as provide visual continuity with the game to improve the user's experience.

The illustrated DVD game remote includes two player controls corresponding to two external input sources, but it is within the scope of this disclosure to include more or fewer player controls, each corresponding one or more external input sources, depending on the requirements of a particular game. Moreover, while the illustrated DVD game remote includes an LED for communicating signals, other embodiments may utilize other optical communication mechanisms, radio communication mechanisms, or virtually any other suitable mode for sending a signal to a DVD player. Some embodiments of the gaming system do not include a game remote and instead may be configured to accept user-provided input from a user-operated control in the form of a conventional remote control for use with the DVD player.

An example game, in which the aforementioned concepts are used, is described in the following paragraphs. For the purpose of simplicity, an example trivia game played using DVD gaming system 20 is presented. It should be understood that the trivia game is provided for the purpose of illustration, and is not meant to be limiting. Although the game is specifically described in the context of specific variables, scripts, clips, stories, scenes, and other attributes, these are provided only for the purpose of illustration. Any number of games may be created using the concepts described in this disclosure. For example, different trivia games, other quiz games, or games with completely different objectives may be created.

FIG. 5A shows an exemplary opening menu screen 48, which may be displayed on television 28 when DVD game medium 22 is played on DVD player 24. Opening menu screen 48 is a DVD menu screen that presents a user or users with several selectable options, which may be used to choose and/or configure a game. For example, at 50, a user may select between one and two players. At 52, a user may select a skill or difficulty level of “amateur,” “expert,” or “pro.” A “bonus round” feature may be turned on or off at 54. Opening menu screen 48 also includes options for starting a new “Trivia Game” at 56 and starting a new “What Happens Next” game at 58.

The number of players, skill level, bonus round setting, and game type may be selected with DVD game remote 26 as described above. For example, up and down buttons 40a-b and 42a-b may be used to toggle among selections and/or settings for each selection, and “buzz in” buttons 44 and/or 46 may be used to choose a setting.

FIG. 5B shows opening menu screen 48 in a configuration set for a one player game, with the difficulty level set to “amateur” and the bonus round feature set to “off.” FIG. 5A may thus represent opening menu screen 48 in a default configuration. FIG. 5B shows opening screen 48 where settings have been changed to designate a two player, “pro” game, with the bonus round feature set to “on.”

Changing settings from default values at opening menu screen 48 effectuates changes in respective variable values held in GPRMs 30. Such changes may be implemented by scripts, or information recorded on DVD game medium 22 comprising instructions to DVD player 24, that are designed to set the game variables to a desired value. For example, some scripts may set a variable to a specific value, or may increment a variable by a predetermined amount. Scripts may implement logical decisions, such as executing or calling other scripts, based on the value of one or more game variables, user input, or both.

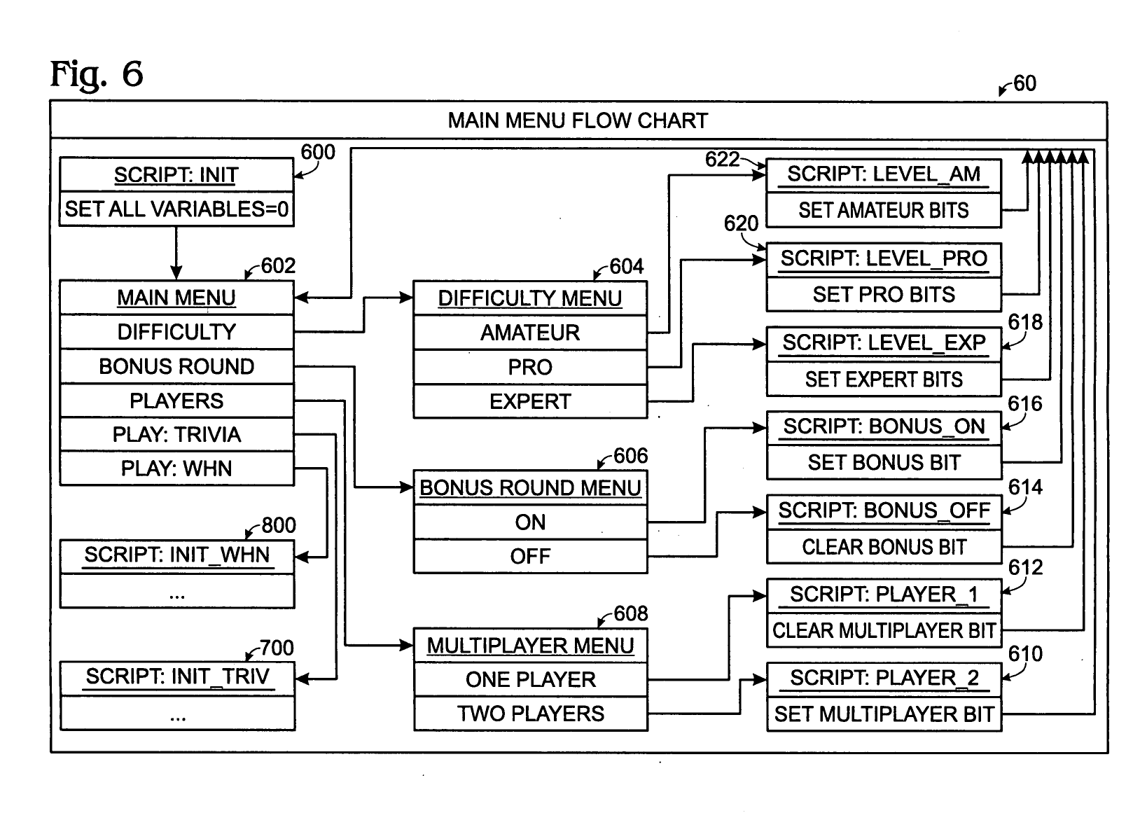

FIG. 6 shows main menu flowchart 60, illustrating an exemplary set of submenus and branching options available from opening menu screen 48, and how different selections may lead to the execution of different scripts.

For example, when a new game is started, an initialization script such as INIT script 600 may run. Such a script may define game variables to be used in playing the game, format the memory storage means of a DVD player by designating how values associated with each variable will be held, and associate an initial or default value to each variable defined. For example, as mentioned above, the first six bits 32a-f of GPRM 30a may be designated by INIT script 600 to hold data corresponding to a “Questions” variable, which may represent the number of questions asked during a particular game. Similarly, bit 32g of GPRM 30a may be used to hold a “Multiplayer” variable or flag. Once defined, INIT script 600 may set all game variables to a default value of “0.”

Continuing this example, the following table shows the game variables that may be held by GPRMs 30a-h, as formatted by INIT script 600:

TABLE 1

| GPRM | BITS | VARIABLE | DESCRIPTION |
|---|---|---|---|
| 30a | 32a-f | NumQuestions | number of questions asked (0-63) |
| | 32g | Multiplayer | 0 = one player; 1 = two players |
| | 32h | BonusRound | 0 = off; 1 = on |
| | 32i-j | Difficulty | 00 = amateur; 01 = pro; 11 = expert |
| | 32k-l | Game | 01 = Trivia Game; 11 = What |
| | | | Happens Next |
| | 32m-n | TriviaUser | 00 = no one answered; |
| | | | 01 = Player One answered; |
| | | | 10 = Player Two answered |
| | 32o-p | EnterPressed | 00 = no player buzzed in; |
| | | | 01 = Player One buzzed in; |
| | | | 10 = Player Two buzzed in |
| 30b | 32a-h | ClipNum | specifies current clip number (0-255) |
| | 32i-p | TrackNum | specifies current track number |
| | | | (0-255) |
| 30c | 32a-h | Player1Score | score for Player One |
| | 32i-p | Player2Score | score for Player Two |
| 30d | 32a-p | Temp1 | temporary variables used in scripts |
| 30e | 32a-p | Temp2 | temporary variables used in scripts |
| 30f | 32a-p | PlayedClips | bitflags for played clips (for random |
| | | | play) |
| 30g | 32a-p | PlayedTracks | bitflags for played tracks (for random |
| | | | play) |
| 30h | 32a-p | Unused | — |

INIT script 600 may present a menu screen such as opening screen 48, displayed on television 28. A main menu 602, corresponding to the selectable options available on opening screen 48, includes submenus such as a difficulty submenu 604, a bonus round submenu 606, and a multiplayer submenu 608, each submenu including possible settings available for that submenu. Selecting two players at the multiplayer submenu 608 runs a PLAYER_{—}2 script 610, which changes bit 32g of GPRM 30a, which holds the “Multiplayer” variable, from “0” to “1.” If one player is selected, the Multiplayer variable is cleared to “0” by PLAYER_{—}1 script 612.

Similarly, a BONUS_OFF script 614, a BONUS_ON script 616, a LEVEL_EXP script 618, a LEVEL_PRO script 620, and a LEVEL_AM script 622 may be run by selecting corresponding options on submenus 604 and 606. These scripts each alter a corresponding variable.

Opening menu screen 48 thus functions as a user interface, and is used to configure a particular game as desired. Once configured, a new “Trivia Game” or a “What Happens Next?” game may be initiated. If a Trivia Game is selected, an INIT_TRIV script 700 is run, which sets the value of the “Game” variable held in bits 32k-l of GPRM 30a to “01.” If a What Happens Next game is selected, the Game variable is set to “11” by an INIT_WHN script 800.

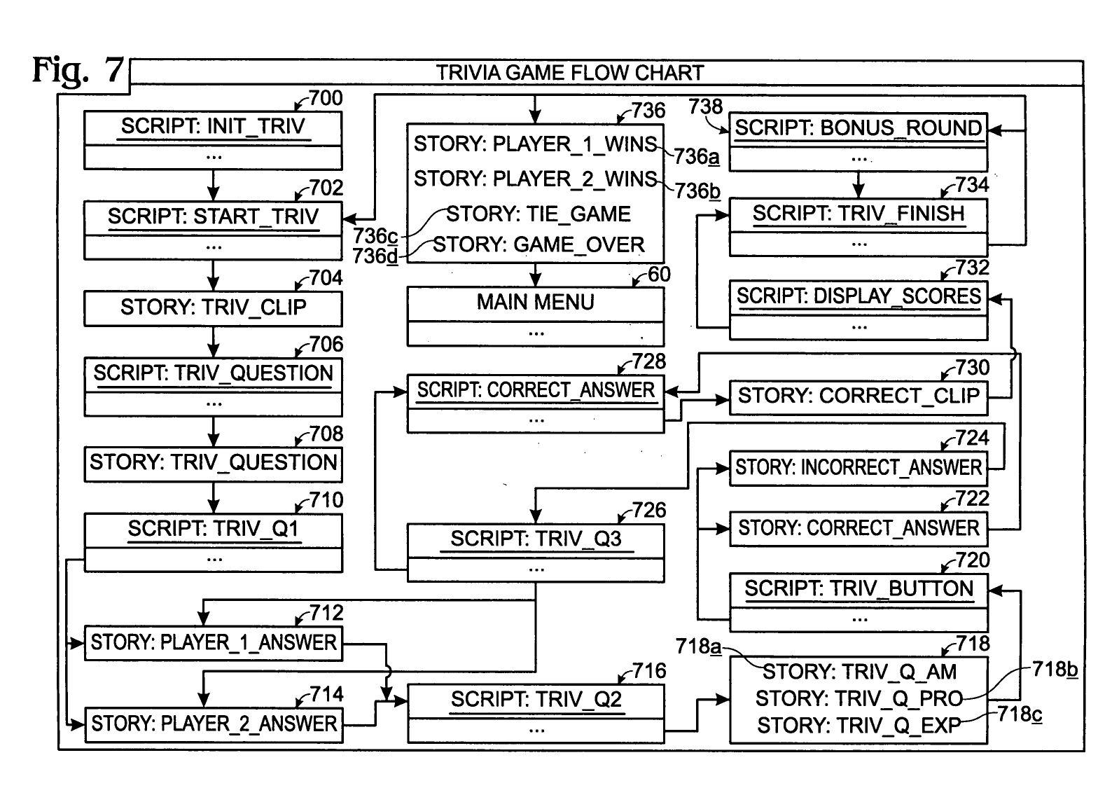

FIG. 7 shows a flowchart that illustrates the progression of a Trivia Game 70, as initiated by INIT_TRIV script 700. In this example, Trivia Game 70 includes a series of scenes that are followed by questions about the scenes. The game may be played by one or more players, who attempt to answer the questions. The game automatically keeps track of each player's score, which reflects the number of questions each player answers correctly. The following summarizes the game flow by tracking the scripts that are run and the scenes that are played during a portion of an exemplary game.

INIT_TRIV script 700 may call a START_TRIV script 702, which in turn may call a Triv_Clip story 704. A story, as the term is used herein, denotes a type of script consisting of instructions to DVD player 24 to play a clip, which may be a particular scene or group of scenes. The particular clip played may be determined by the value of a game variable such as the “TrackNum” variable stored in bits 32i-p of GPRM 30b. Thus, START_TRIV script 702 checks the value of the TrackNum variable and chooses an appropriate clip to be played. Triv_Clip story 704 instructs DVD player 24 to play the clip chosen. After each question of the trivia game is asked, START_TRIV script 702 may change the value of the TrackNum variable so that the same question is not repeatedly asked. The modification may be sequential, random, or according to some other ordering scheme.

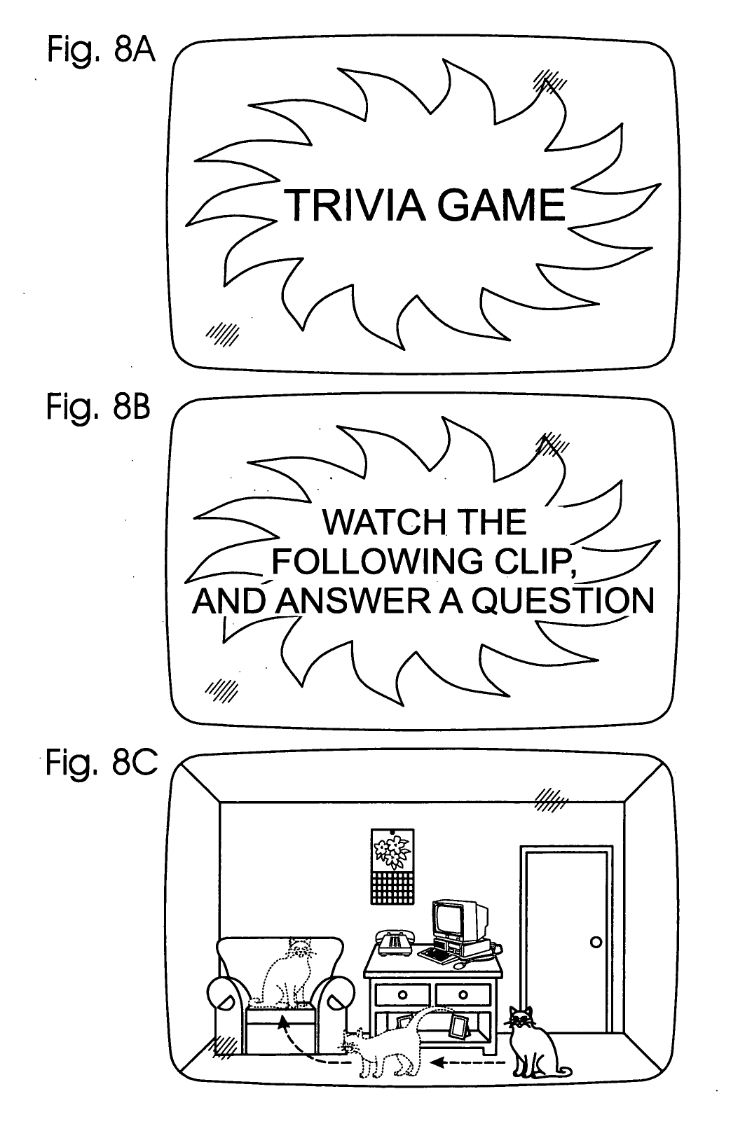

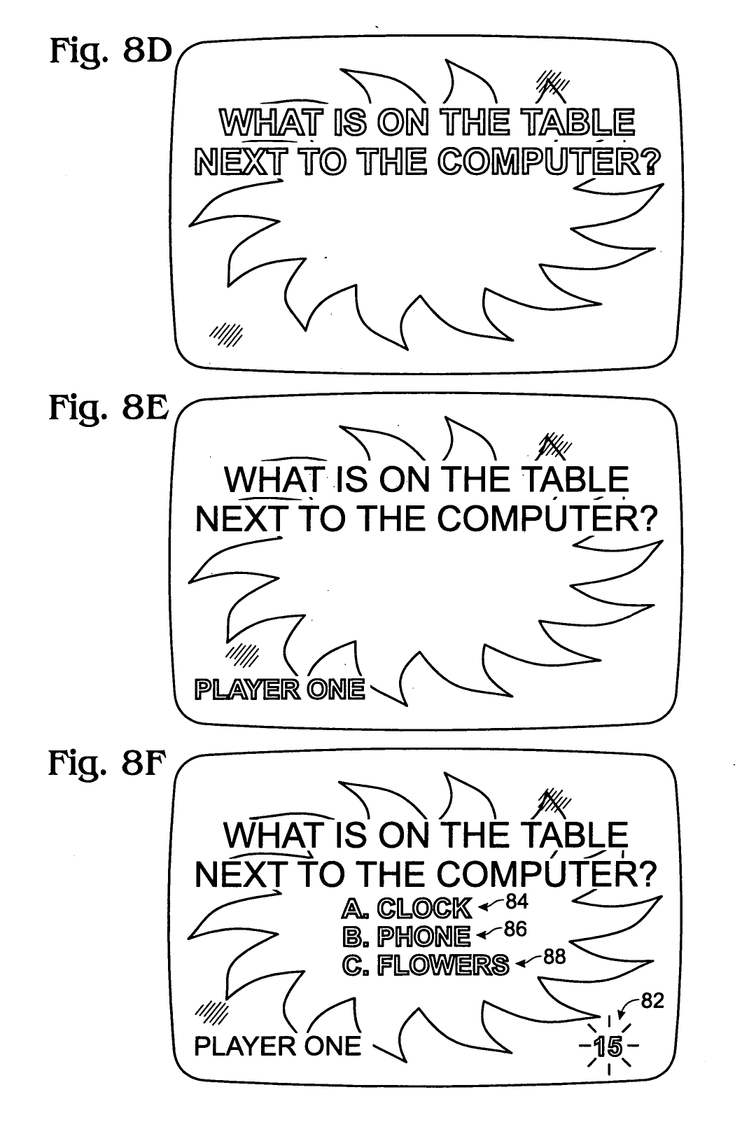

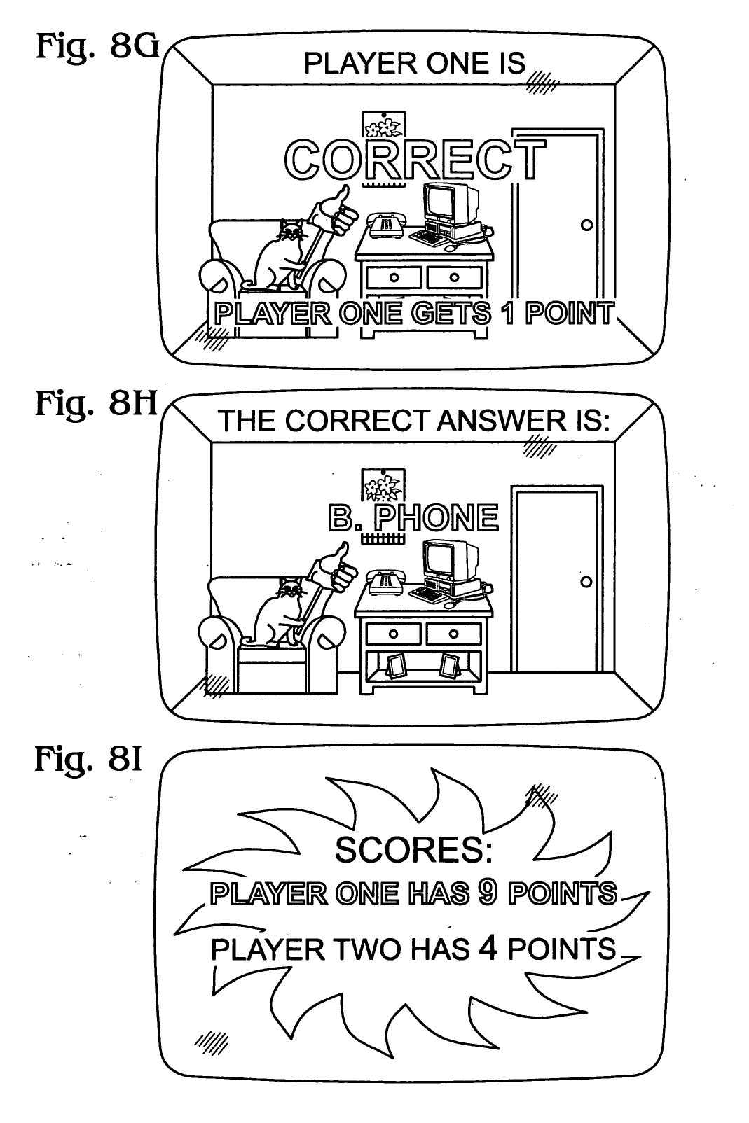

Triv_Clip story 704 may play a scene from a cartoon, or a sequence of scenes including textual instructions to the players to watch the scene about to be played and/or to answer the question presented after the scene has been played. FIGS. 8A, 8B, and 8C show example representations of parts of a clip that may be played by Triv_Clip 704 and displayed on television 28. FIG. 8A shows a game start scene, and FIG. 8B shows a scene containing textual instructions to the players. FIG. 8C shows a scene featuring a cartoon setting with an animated component, the animation represented by dashed lines.

After the clip is played, TRIV_QUESTION script 706 calls a Triv_Question story 708 which presents a question based on the scene that was played immediately before the question. An example of a scene played by Triv_Question story 708 is shown in FIG. 8D.

When the question scene is presented, a TRIV_Q1 script 710 may wait for input from an external input source such as player controls 36a and 36b. If the game is set for two-player mode, TRIV_Q1 script 710 may pause until receiving input indicating that one player knows the answer before the other. As described in detail above, a user may answer via DVD game remote 26, for example by “buzzing in” with a player control to indicate that the user would like to answer the question.

After receiving input that a particular player knows the answer, TRIV_Q1 script 710 keeps track of which external input source has provided the indication by setting the “TriviaUser” variable value held by bits 32m-n of GRPM 30a. For example, in a two-player game, TRIV_Q1 script 710 may set the TriviaUser variable to “01” if the indication is made by the first player or to “10” if the indication is made by the second player. If TRIV_Q1 script 710 receives no input, indicating that neither player has “buzzed in,” the TriviaUser variable may remain set at the default value “00.”

If TRIV_Q1 script 710 has received an indication that a player knows the answer, a clip is played that allows the indicating player to enter an answer. For example, if the first player makes the indication, the game plays Player_{—}1_Answer story 712 and if the second player makes the indication, the game plays Player_{—}2_Answer story 714. An example of a scene displayed by Player_{—}1_Answer story 712 is shown in FIG. 8E, which is similar to that shown in FIG. 8D, but with highlighted text indicating that Player One has “buzzed in.”

TRIV_Q2 script 716 may determine how much time the indicating player has to answer the question, based on the difficulty level selected at opening menu screen 48. TRIV_Q2 script 716 may then call a story 718, which plays a video clip corresponding to the set difficulty level. The video clip may include a countdown timer to indicate the amount of time remaining in which a player must answer the question presented. For example, if the difficulty is set to “amateur,” TRIV_Q2 script 716 may call Triv_Q_am story 718a, which in turn may play a clip including a scene with a feature to indicate the time remaining to answer a question presented. FIG. 8F shows an example scene played by Triv_Q_am story 718a, which can be seen to include a changing numerical “countdown timer” 82 corresponding to the number of seconds the designated player has in which to answer the question. Similarly, other difficulty settings may prompt TRIV_Q2 script 716 to call Triv_Q_pro story 718b or Triv_Q_exp story 718c, each of which may play scenes similar to that shown in FIG. 8F, but corresponding to shorter periods of time in which the question may be answered.

The clip played by story 718 may also present a choice of possible answers, indicated in FIG. 8F at 84, 86, and 88, one or more of which may be correct. DVD game remote 26 may be used to select among possible answers, and a TRIV_BUTTON script 720 may run one of several possible scripts based on different input accepted from DVD game remote 26, such as “up” or “down” commands to scroll through possible answers, or a “buzz-in” command from a user, selecting a possible answer. For example, FIG. 8F shows possible answer 84 highlighted. If an “up” or “down” command is provided, TRIV_BUTTON script 720 may simply play a clip similar to the one displayed in FIG. 8F, with a different possible answer highlighted. If a “buzz-in” command is received, selecting the answer highlighted or otherwise indicated, TRIV_BUTTON script 720 may call a story based on which answer is selected.

If a correct answer is selected, TRIV_BUTTON script 720 increments the score for the answering player by one point, based on the value held by the TriviaUser variable set by TRIV_Q1 script 710. Thus, if a correct answer was selected and the TriviaUser variable holds the value of “01,” corresponding to Player One, TRIV_BUTTON script 720 may increment the value corresponding to the “Player1Score” variable stored in bits 32a-h of GPRM 30c by one. Similarly, if a correct answer was selected and the TriviaUser value corresponds to Player Two, script 720 may increment the value of “Player2Score” variable by one. Analogously, if an incorrect answer is selected, script 720 may decrease the value of the answering player's score variable by one.

If the question is correctly answered, a Correct_Answer story 722 is called, which may play a scene indicating that a correct answer has been selected. An example of such a scene is shown in FIG. 8G. If an incorrect answer is selected, an Incorrect_Answer story 724 is called, which may play a scene to indicate that the answer selected is incorrect. Incorrect_Answer story 724 may then call a TRIV_Q3 script 726, providing the other player with an opportunity to answer.

In either case, when a correct answer is selected, a CORRECT_ANSWER script 728 is called that plays a Correct_Clip story 730, which in turn may play a scene indicating the correct answer (or answers) to the question presented, as shown, for example, in FIG. 8H. A DISPLAY_SCORES script 732 may then plays a scene or scenes reflecting the current scores according to the respective Player1Score and Player2Score score variables. The score scenes played are selected based on the stored values of such variables. For example, in a one player game, only one player score scene may be displayed. In a multiplayer game, both score scenes may be displayed in sequence, or a scene indicating both players' scores simultaneously may be displayed. FIG. 8I shows an example of a score scene indicating both players' scores simultaneously.

A TRIV_FINISH script 734 is called after DISPLAY_SCORES script 732 has run. TRIV_FINISH script 734 increments the value of the “NumQuestions” variable, which allows Trivia Game 70 to keep track of the total number of questions that have been asked. TRIV_FINISH script 734 then may enter a decision branch to determine if the game should continue or end, wherein the determination is made as a function of values held by variables representing: scores held by each player, the number of questions that have been asked, and whether or not the bonus round option has been selected.

For example, Trivia Game 70 may be configured to end if a player has scored ten points, or if forty questions have been asked. Accordingly, TRIV_FINISH script 734 may check the values held by the score variable corresponding to each player, check the value held by the NumQuestions variable, and call a story or script based on one of several possibilities. For example, in a multiplayer game in which one of the players has reached ten points, TRIV_FINISH script 734 may call either a Player_{—}1_Wins story 736a or a Player_{—}2_Wins story 736b, each of which may play a scene to indicate the player that has won the game. Or, if forty questions have been asked but neither player has reached ten points, TRIV_FINISH script 734 may call a Tie_Game story 736c, which may play a tie game scene. In a single player game in which forty questions have been asked but the player has not reached ten points, TRIV_FINISH script 734 may call a Game_Over story 736d, which may play a scene indicating that the game is over. After any of story 736a-d are called, opening menu screen 48 may be presented and a new game may be selected and/or configured.

Continuing the example above, in a game in which less than forty questions have been asked but no player has scored ten points, Trivia Game 70 may continue. If the “BonusRound” variable is “on,” TRIV_FINISH script 734 may call BONUS_ROUND script 738, which may then ask subsequent questions about the previous scene, allowing a player to score more points. If the BonusRound variable is “off,” TRIV_FINISH script 734 may instead call START_TRIV script 702, beginning a new sequence of presenting a question to the player or players and continuing game play.

Trivia Game 70 as described is a specific example of a single game that may be played using DVD gaming system 20. Virtually any number of other games is within the scope of this disclosure. For example, opening menu screen 48 of FIG. 5A features an option to start a “What Happens Next?” game at 58, initiated by INIT_WHN script 800 (see FIG. 7). Such a game may be similar to Trivia Game 70, except that players may be shown a scene and then asked what happens after the scene is completed, instead of being asked a question about what already happened in the scene. Other games may feature games structured by using game scripts to determine content to be played and game variable values to be changed as functions of input accepted from external data sources and values held by one or more variables.

The above described games demonstrate embodiments using GPRMs to store values associated with a set of defined variables, which may be used to control game flow. The variables may be used by scripts, which implement logical decisions as functions of the value of specific variables, input received from an external input source, other game factors, or some combination thereof.

As described above, a game may include a number of specialized scenes, which may be formatted as chapters of a DVD. For example, a different scene may be included for every possible score in a game, so that a scene may be played to properly display the score, because a DVD cannot modify a single scene in real-time to display different scores. Also, game elements with time restrictions may be implemented by setting the length of a scene, and requiring a user to take action before the scene ends, or within a specified time period after the scene ends. As described above, the time left to make a selection may be reported to the user via the use of a countdown timer.

Embodiments of the game according to the present disclosure may be configured for single player or multiplayer play. Such embodiments may include options which may be differently configured each time the game is played. For example, the embodiments described above have different difficulty levels and a bonus round that may be selectively activated or deactivated. Other embodiments may have virtually any other type of user selectable option. The selected options may be tracked by variables stored in the GPRMs, or other useable DVD memory.

It is believed that this disclosure encompasses multiple distinct inventions with independent utility. While each of these inventions has been described in its best mode, numerous variations are contemplated. All -novel and non-obvious combinations and subcombinations of the described and/or illustrated elements, features, functions, and properties should be recognized as being included within the scope of this disclosure. Applicant reserves the right to claim one or more of the inventions in any application related to this disclosure. Where the disclosure or claims recite “a,” “a first,” or “another” element, or the equivalent thereof, they should be interpreted to include one or more such elements, neither requiring nor excluding two or more such elements.

1. An interactive DVD gaming system comprising:
a DVD and a user-operated control for use with a DVD player, the DVD player being configured to accept game input from the user-operated control and to hold one or more game variables, each game variable having a value;
wherein the user-operated control is configured to provide user-provided game input to the DVD player; and
wherein the DVD includes data readable by the DVD player; said data including at least one sequence of audiovisual content and one or more game scripts operable to:
define a game variable;
associate a value with a game variable defined;
change a value of the game variable as a function of game input accepted from a user-operated control and the value of the game variable.

2. The system of claim 1 wherein the user-operated control is further configured to distinguish among input from a plurality of external input sources.

3. The system of claim 1 wherein the DVD is formatted according to the DVD-Video Standard.

4. In combination with a DVD player having memory storage means and being responsive to user-provided input, the improvement comprising a DVD having recorded thereon audiovisual content and a plurality of game scripts executable by the DVD player, wherein the plurality of game scripts performs actions comprising:
defining a game variable;
formatting the memory storage means of the DVD player to hold a value associated with the game variable;
associating a value with the game variable;
changing, as a function of the value associated with the game variable and user-provided input, the value associated with the game variable;
selecting, as a function of the value associated with the game variable and user-provided input, audiovisual content; and
playing the audiovisual content selected.

5. The improvement of claim 4, wherein the plurality of game scripts performs changing the value of the game variable at least twice.

6. The improvement of claim 4, in combination with a DVD player of the type including memory storage means to store less than 1 kilobyte of data.

7. The improvement of claim 4, in combination with a DVD player configured with memory insufficient to dynamically alter a scene played during game play.

8. The improvement of claim 4, in combination with a DVD player having a user-operated control to transmit user-provided input to the DVD player.

9. The improvement of claim 8, wherein the plurality of game scripts further performs distinguishing among user-provided input from a plurality of external input sources.

10. The improvement of claim 4 further comprising a user-operated control configured to transmit user-provided input to the DVD player.

11. The improvement of claim 10 wherein the user-operated control is further configured to distinguish among user-provided input from a plurality of external input sources.

12. The improvement of claim 4 wherein the DVD is formatted according to the DVD-Video Standard.

13. A method for playing an interactive DVD game, comprising:
providing a DVD for use with a DVD player, the DVD player including memory storage means and being configured to accept input from an external input source;
defining a game variable;
formatting the memory storage means of the DVD player to hold a value associated with the game variable;
associating a value with the game variable;
changing, as a function of the value associated with the game variable and input accepted from an external input source, the value associated with the game variable;
selecting, as a function of the value associated with the game variable and input accepted from an external input source, audiovisual content; and
playing the audiovisual content selected.

14. The method of claim 13, wherein the DVD player includes less than 1 kilobyte of memory.

15. The method of claim 13 wherein defining a game variable includes defining a score variable.

16. The method of claim 15 wherein associating includes assigning a zero value to a score variable.

17. The method of claim 16 wherein changing includes incrementing the value of the score variable by a predetermined amount.

18. The method of claim 17, further including displaying a value of the score variable.

19. The method of claim 17, wherein the DVD player is configured to provide output to a television responsive to the DVD player, and wherein playing includes displaying a value of the score variable on the television.

20. The method of claim 13, further comprising:
distinguishing among input accepted from two or more external input sources.

21. The method of claim 13, wherein changing the value of the game variable is performed at least twice.

22. The method of claim 13 wherein the DVD is formatted according to the DVD-Video Standard.

23. A method for playing an interactive DVD game, comprising:
providing a DVD and a user-operated control for use with a conventional DVD player, the DVD player including memory storage means and being configured to accept game input from the user-operated control;
defining a game variable;
formatting the memory storage means of the DVD player to hold a value associated with the game variable;
associating a value with the game variable;
changing, as a function of the value associated with the game variable and input accepted from a user-operated control, the value associated with the game variable;
selecting, as a function of the value associated with the game variable and input accepted from a user-operated control, audiovisual content; and
playing the audiovisual content selected.

24. The method of claim 23, wherein the user-operated control is configured to distinguish among two or more external input sources providing game input.

25. The method of claim 23, further comprising:
distinguishing among two or more external sources of game input.

26. The method of claim 23 wherein the DVD is formatted according to the DVD-Video Standard.
